(19) United States
(12) Patent Application Publication
(10) Pub. No.: US 2011/0254940 A1
(43) Pub. Date: Oct. 20, 2011

(54) IMAGE DISPLAY DEVICE HAVING SHOOTING FUNCTION

(75) Inventors: Yoshinobu SUZUKAWA, Osaka (JP); Yutaka KITAMORI, Osaka (JP)

(73) Assignee: SANYO ELECTRIC CO., LTD., Osaka (JP)

(21) Appl. No.: 13/085,842

(22) Filed: Apr. 13, 2011

(30) Foreign Application Priority Data
Apr. 14, 2010 (JP) 2010-092734

(51) Int. Cl. H04N 7/18

(52) U.S. Cl. 348/77; 348/E07.085

(57) ABSTRACT

An image display device includes: a display surface that displays an image by emitting light; a camera that shoots a subject; a moving image obtaining portion that obtains a moving image by making the camera perform shooting of a moving image of the subject; and a merged image generating portion that, when the shooting of the moving image of the subject is performed, generates a merged image and makes the display surface display the merged image. A shot image region and a high-luminance region are provided in predetermined positions in the merged image, the moving image being assigned to the shot image region, and the high-luminance region having luminance higher than the luminance of the shot image region.

This application is based on Japanese Patent Application No. 2010-092734 filed on Apr. 14, 2010, the contents of which are hereby incorporated by reference.

### BACKGROUND OF THE INVENTION

1. Field of the Invention

The present invention is related to an image display device having a function of shooting a subject.

2. Description of Related Art

People sometimes try to view themselves to, for example, check their appearance in their daily lives. On such an occasion, since it is difficult to view themselves directly with their eyes, people use a mirror in which to reflect their appearance.

There has been proposed a device that has a function of shooting a subject and displaying the resulting image and thus can be used as a mirror (a substitute for a mirror) for reflecting the appearance of the subject. Such a device that can be used as a substitute for a mirror allows a user to check his or her appearance by looking at his or her shot image displayed on the device instead of looking at a mirror.

As an example of a device that can be used as a substitute for a mirror, there has been proposed a device that processes image data obtained by shooting a user by a plurality of cameras and displays on a screen an image of the user as viewed from a desired direction.

Unlike an ordinary mirror, the above-described device usable as a substitute for a mirror can be provided with various additional functions. For example, it is possible to allow image data to be processed as required, to thereby increase the number of variations of display states.

Another possibility is to have a display device (such as a TV broadcast receiver, a mobile phone terminal, or a personal computer) produced for another purpose and provided with a function of substituting for a mirror (i.e., the display operates to function as a substitute for a mirror as necessary), to thereby achieve effective use of the display. From the foregoing, it can be said that the device usable as a substitute for a mirror has a wider range of application than an ordinary mirror, and thus is useful.

An optical image of an object is formed by light reflected from the object. Thus, if a sufficient amount of light is not secured to illuminate an object, the object appears to be dark. If a subject of shooting is dark, an obtained shot image will be so dark that it is difficult to see the image. In particular, if part of a subject is dark, it will lead to great unevenness in brightness of the resulting shot image, which may cause a user to feel something wrong with the shot image.

Thus, to obtain a preferable shot image, it is important to keep the brightness of the subject at an appropriate level. This is true with the above-described device usable as a substitute for a mirror. If a user himself/herself is not illuminated as a subject to proper brightness, it is difficult for the user to preferably view himself or herself Incidentally, with an ordinary mirror as well, it is necessary for a user to be illuminated to proper brightness for the user to preferably view himself or herself.

A possible remedy for the above-described problem is to provide the device with a function of processing image data to thereby adjust the brightness of a shot image (an image quality adjusting function). However, it is important to keep the brightness of a subject itself at an appropriate level to obtain a shot image that looks as natural as possible. Here, additional provision of a shooting light (for brightly illuminating a subject) would require an installation space to be secured for the shooting light or require a new component, which prevents reduction of the price and size of the device.

### SUMMARY OF THE INVENTION

According to the present invention, an image display device includes: a display surface that displays an image by emitting light; a camera that shoots a subject; a moving image obtaining portion that obtains a moving image by making the camera perform shooting of a moving image of the subject; and a merged image generating portion that, when the shooting of the moving image of the subject is performed, generates a merged image and makes the display surface display the merged image. Here, the image display device stores a plurality of kinds of display patterns indicating display states that are different from one another in luminance, and a shot image region and a light region are provided in predetermined positions in the merged image, the moving image being assigned to the shot image region, and any of the plurality of kinds of display patterns being assigned to the light region.

### BRIEF DESCRIPTION OF THE DRAWINGS

FIG. 1 is a block diagram showing the structure of an image display device embodying the present invention.

FIG. 2 is an external view of the image display device.

FIG. 3 is a schematic diagram illustrating the positional relationship between the image display device and a subject.

FIG. 4 is another schematic diagram illustrating the positional relationship between the image display device and a subject.

FIG. 5 is a schematic diagram illustrating display in a television broadcast receiving mode.

FIG. 6 is a schematic diagram illustrating the structure of a merged image.

FIG. 7 is a table of the contents of display patterns.

FIG. 8 is a schematic diagram illustrating light emitted from a light region.

FIG. 9 is another schematic diagram illustrating light emitted from the light region.

FIG. 10 is a flow chart of an operation procedure in a mirror mode.

FIG. 11 is a schematic diagram illustrating display in the mirror mode.

FIG. 12 is a flow chart of a display pattern choosing operation.

FIG. 13 is a schematic diagram illustrating the display pattern choosing operation.

FIG. 14 is a table of correspondence between luminance shortage values and adopted display patterns.

FIG. 15 is a schematic diagram illustrating how a communication system is used.

FIG. 16 is a schematic diagram illustrating a communication system.

### DETAILED DESCRIPTION OF PREFERRED EMBODIMENTS

An embodiment of the present invention will be described below, dealing with, as an example, an image display device that displays television broadcast images and shot images. As will be described later, the image display device is structured to be usable not only as a television broadcast receiver but also as a substitute for a mirror.

[Structure of Image Display Device, etc.]

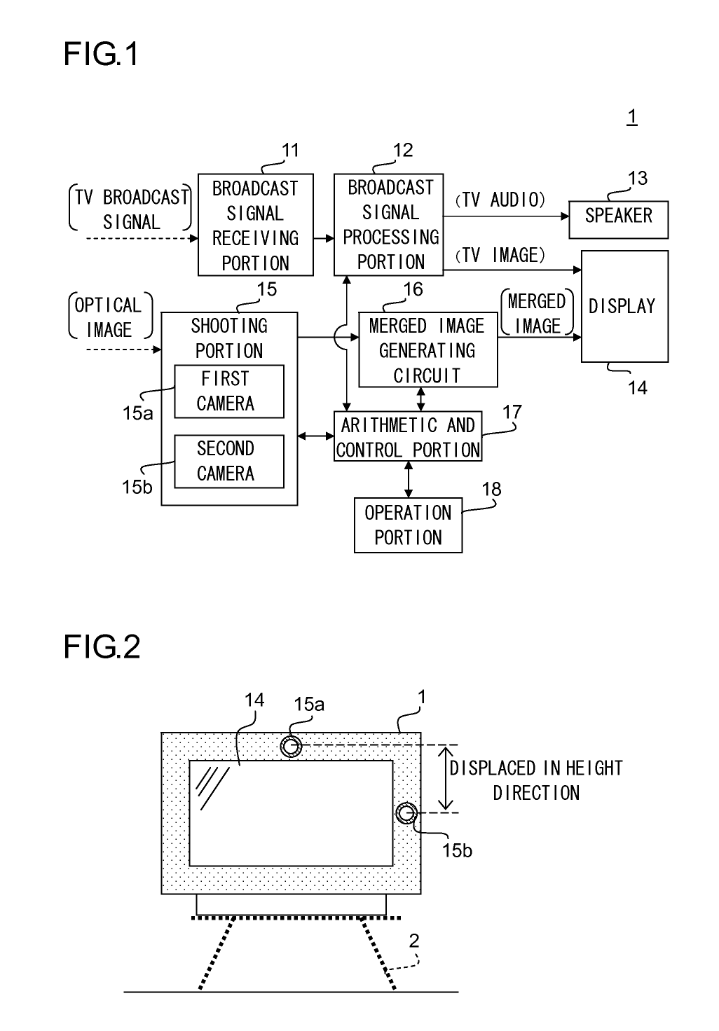

FIG. 1 is a diagram showing the structure of the image display device. As shown in the figure, the image display device 1 includes: a broadcast signal receiving portion 11; a broadcast signal processing portion 12; a speaker 13; a display 14; a shooting portion 15; a merged image generating circuit 16; an arithmetic and control portion 17; an operation portion 18; and the like. Next, descriptions will be given of these components.

The broadcast signal receiving portion 11 is connected, for example, to an antenna, and accepts input of a broadcast signal of television broadcast. The broadcast signal includes image and audio information of a television program. The broadcast signal receiving portion 11 includes a tuner with which to perform tuning processing on the broadcast signal, and sends the signal of a tuned channel to the latter stage side. Which channel to select, etc., is determined according to an instruction from a user.

The broadcast signal processing portion 12 performs predetermined processing (processing of performing demodulation and decoding, processing of adjusting images and audio, etc.) on the broadcast signal received from the broadcast signal receiving portion 11. Thereby, the broadcast signal processing portion 12 generates an image signal including information of images of a television program and an audio signal including audio information of a television program. The generated image signal is sent to the display 14, and the audio signal is sent to the speaker 13. The speaker 13 is formed to output audio based on the audio signal received from the broadcast signal processing portion 12.

The display 14 is formed with, for example, a PDP (plasma display panel) or a liquid crystal display, and has a function of performing various kinds of display based on the image signal that it receives. The display surface of the display 14 (which will hereinafter be referred to simply as a “display surface”) is formed in a rectangular shape, and has a plurality of pixels whose luminance is adjusted arranged all over the display surface. The display 14 adjusts the luminance of each pixel to thereby perform the various kinds of display. The display surface can also be regarded as displaying images by emitting light.

The shooting portion 15 includes two cameras (a first camera 15a and a second camera 15b) that shoot a subject. The shooting portion 15 makes either or both of the cameras perform shooting of a still image or a moving image according to an instruction from the arithmetic and control portion 17. Data of an image (shot image) obtained by the shooting is sent to the merged image generating circuit 16 or to the arithmetic and control portion 17. The term “moving image” in the following descriptions indicates a moving image obtained as a result of moving image shooting performed by the shooting portion 15. As to shooting intervals and the like in the moving image shooting, various embodiments are possible.

The merged image generating circuit 16 generates a merged image by using the data received from the shooting portion 15. A detailed description of the structure and the like of the merged image will be given later.

The arithmetic and control portion 17 is formed with a CPU, for example; the arithmetic and control portion 17 controls each portion of the image display device 1 and performs necessary processing such that the image display device 1 operates normally. The main operation performed in the image display device 1 will be described later.

The operation portion 18 includes button switches and a remote control unit (a remote controller), and accepts operation input (instruction) by a user. The content of the operation input is sent to the arithmetic and control unit 17, and is reflected in various operations of the image display device 1.

FIG. 2 is an external view of the image display device 1 as seen from the front side. As shown in the figure, the image display device 1 has the display 14 disposed on the front side thereof, and is used by being placed on a rack 2 or the like.

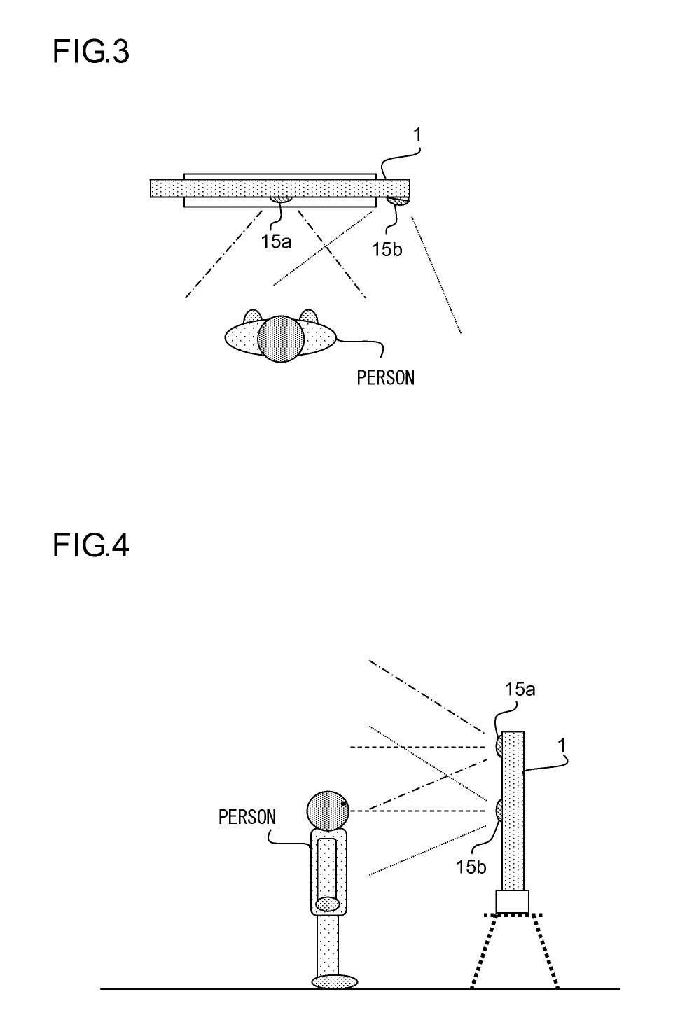

It is assumed that a subject of shooting performed by the shooting portion 15 of the image display device 1 is, as shown in FIGS. 3 and 4, a person (specifically the face of the person) who is present substantially straight in front of the display surface (that is, positioned in front of the display surface to face substantially the center of the display surface). Incidentally, FIG. 3 is a diagram showing what the image display device 1 shown in FIG. 2 looks like when it is seen from above, and FIG. 4 is a diagram showing what the image display device 1 shown in FIG. 2 looks like when it is seen from the right side.

Thus, the shooting range of each of the cameras (15a, 15b) is set such that the face of a person present substantially straight in front of the display surface is recognized as a subject. Incidentally, the subject is positioned in front of the display surface and illuminated by light emitted from the display surface.

The cameras (15a, 15b) are located in different positions that are displaced from each other in a height direction (the up-down direction in FIG. 2), such that the shooting ranges of the cameras are displaced from each other in the height direction. This makes it easy, as will be described later, to properly shoot persons of different heights as subjects.

[Outline of the Operation of the Image Display Device]

Next, the outline of the operation of the image display device 1 will be described. The image display device 1 is provided with, as operation modes thereof (predetermined operation procedures), a “television broadcast receiving mode” and a “mirror mode” to one of which the operation mode is switchably set. The image display device 1 operates according to the currently set operation mode. The setting of the operation mode is switched, for example, in response to a switching instruction given (a predetermined operation performed on the operation portion 18) by the user.

Here, the “television broadcast receiving mode” is an operation mode for using the image display device 1 as a television broadcast receiver. While the operation mode is the “television broadcast receiving mode,” the broadcast signal receiving portion 11 and the broadcast signal processing portion 12 are operated to generate image and audio signals related to television broadcast. The image and audio signals generated in this way are sent to the speaker 13 and the display 14, respectively.

Thereby, image display and audio output of a television program are realized. That is, by selecting the “television broadcast receiving mode” as the operation mode, the image display device 1 can be used as an ordinary television broadcast receiving apparatus. Incidentally, here, as shown in FIG. 5, the image display is performed by using the whole area of the display surface.

On the other hand, the “mirror mode” is an operation mode for using the image display device as a substitute for a mirror. While the operation mode is the “mirror mode,” the image display device 1 displays a merged image, which is generated by the merged image generating circuit 16, on the display 14, to thereby operate as a substitute for a mirror.

[Structure of the Merged Image]

Before describing the operation procedure of the “mirror mode,” a structure and usage of the merged image used in the “mirror mode” will be described. First, the structure of the merged image will be described.

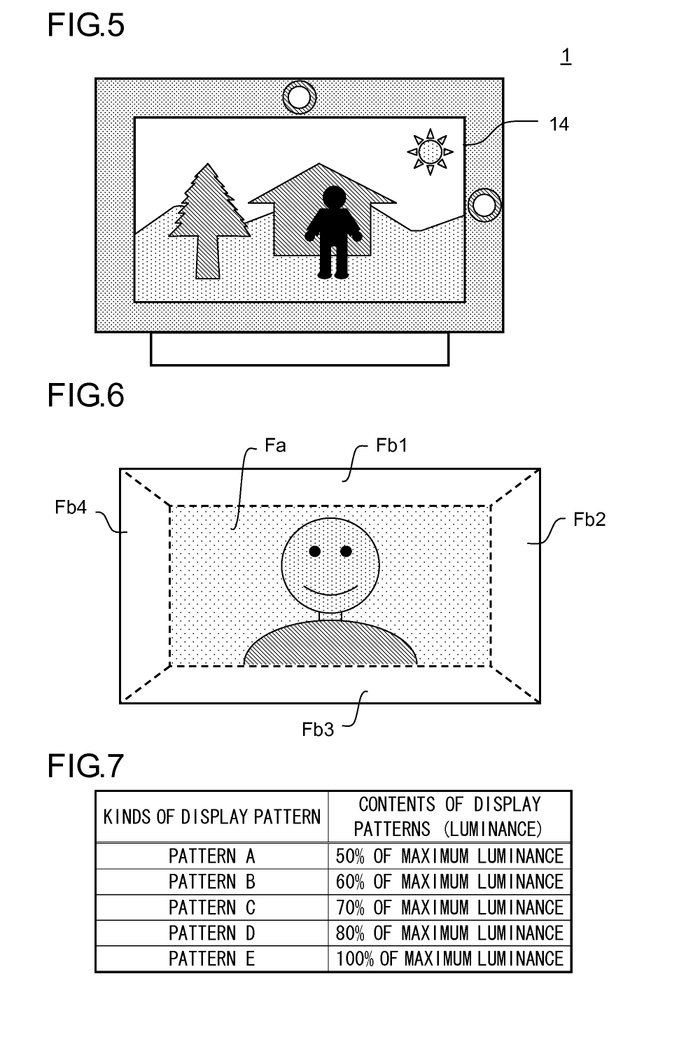

FIG. 6 shows the structure of the merged image. As shown in FIG. 6, the merged image is formed in a shape (rectangular shape) that is similar to the shape of the display surface, and a given area in the center thereof is a shot image region Fa. In the merged image, a given region arranged along the upper side thereof (a region on the upper side) is a first light region Fb1, a given region arranged along the right side thereof (a region on the right side) is a second light region Fb2, a given region arranged along the lower side thereof (a region on the lower side) is a third light region Fb3, and a given region arranged along the left side thereof (a region on the left side) is a fourth light region Fb4.

Locations of the shot image region Fa and the light regions (Fb1 to Fb4) in the merged image are determined in this way. If all the light regions are together regarded as a region, it is possible to say that the region is divided into the light regions (Fb1 to Fb4). In addition to the above embodiment, many other embodiments are possible with respect to the shape and location of each light region and the number of the light regions, or they may be variable.

The shot image region Fa is a region to which is assigned a moving image of a subject obtained by the shooting portion 15. The light regions (Fb1 to Fb4) are each a region to which a currently set display pattern is assigned as a property thereof.

Here, the “display pattern” indicates a state of display in a single color with set luminance (so-called a solid display state), and its contents and the like are recorded in the image display device 1 in advance. As the display pattern, as shown in FIG. 7, there are provided five kinds of display patterns, namely, pattern A to pattern E. Pattern A indicates display in which luminance of each pixel in the region is 50% of the maximum luminance.

Likewise, pattern B indicates display in which luminance of each pixel in the region is 60% of the maximum luminance. Pattern C indicates display in which luminance of each pixel in the region is 70% of the maximum luminance. Pattern D indicates display in which luminance of each pixel in the region is 80% of the maximum luminance. Pattern E indicates display in which brightness of each pixel in the region is 100% of the maximum luminance.

In this way, the display patterns indicate display states that are different from each other in luminance, and as the display pattern shifts from pattern A to pattern B, pattern C, pattern D, and pattern E, the luminance of the display state is increased (that is, the display state is brighter). In addition to the above embodiment, various other embodiments are possible with respect to the number and contents of the display patterns.

These display patterns (patterns A to E) are different from each other in luminance, but the colors thereof are unified to white. As a result, light emitted when each of the display patterns is displayed has a color similar to fluorescent lamp light or natural light (a right color for a shooting light). However, as to the color of the display patterns, various other embodiments are possible including one adopting a gray scale.

Any of the above-described plurality of display patterns is updatably and individually set for each of the light regions (Fb1 to Fb4). Regardless of the state of the shot image region Fa, the display states of the light regions (Fb1 to Fb4) are each maintained the same until the set display pattern is updated.

[Usage and the like of the Merged Image]

As described above, the merged image has the shot image region Fa and the light regions (Fb1 to Fb4) formed therein, each of which has a particular role.

The shot image region Fa has a role of bringing the display surface into a state in which the display surface functions as if it were a mirror. That is, when a person is a subject, an image of the person is displayed in the shot image region Fa. Thus, when the merged image is displayed on the display surface, the person is able to see his or her own image by looking at the display 14 instead of a mirror.

The brightness of a subject as a target of shooting is affected by factors such as the intensity of light (illumination light, etc.) illuminating the subject from outside, the direction of irradiation, and the position of a light source. In the image display device 1, since the subject (a person) is assumed to be positioned substantially straight in front of the display 14, light emitted from the display surface also functions as light for illuminating the subject (that is, the light emitted from the display surface affects the brightness of the subject).

By making use of this fact, the image display device 1 adjusts the intensity of light emitted from (appropriately sets the display pattern of) each of the light regions (Fb1 to Fb4) to thereby adjust the brightness of the subject. That is, each of the light regions (Fb1 to Fb4) has a role of bringing the display surface into a state in which the display surface functions as if it were a shooting light.

Each of the light regions (Fb1 to Fb4) are arranged in different positions on the display surface. Thus, how light illuminates the subject depends on from which light region the light is emitted.

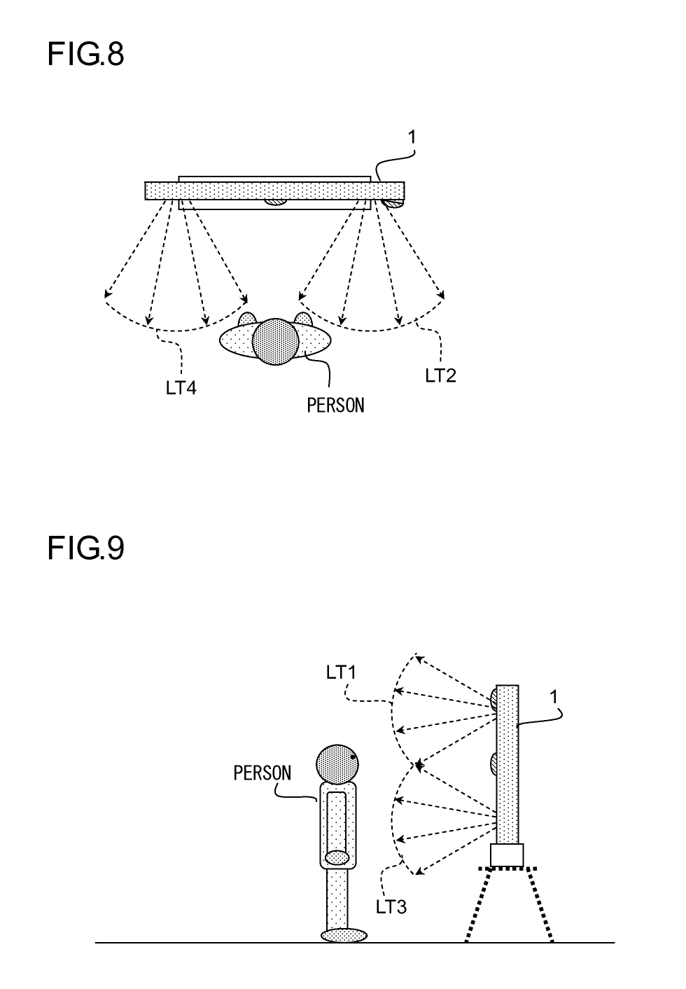

A more detailed description will be given in this regard, with reference to FIGS. 8 and 9. FIG. 8 schematically shows irradiation directions of light and positions of light sources, with respect to light LT2 emitted from the second light region Fb2 and light LT4 emitted from the fourth light region Fb4. FIG. 9 schematically shows irradiation directions of light and positions of light sources, with respect to light LT1 emitted from the first light region Fb1 and light LT3 emitted from the third light region Fb3. Incidentally, FIG. 8 is a view as seen from the same direction as FIG. 3, and FIG. 9 is a view as seen from the same direction as FIG. 4.

As shown in FIG. 6, the second light region Fb2 is arranged on the right side of the merged image. Thus, when the merged image is displayed on the display surface, the second light region Fb2 is displayed on the right side of the display surface. Thus, light LT2 emitted therefrom, as shown in FIG. 8, illuminates the subject that is positioned substantially straight in front of the display surface from the front-right side.

Thus, the light LT2 emitted from the second light region Fb2 mainly affects the brightness of the right-side part of the subject. That is, the more intense the light LT2 is (in other words, the higher the luminance of the second light region Fb2 is), the brighter mainly the right-side part of the subject is.

From the same reason, light LT4 emitted from the fourth light region Fb4 mainly affects the brightness of the left-side part of the subject. Light LT1 emitted from the first light region Fb1 mainly affects the brightness of the upper-side part of the subject. Light LT3 emitted from the third light region Fb3 mainly affects the brightness of the lower-side part of the subject.

The luminance of each of the light regions (Fb1 to Fb4) affects the brightness of each part of the subject, and as a result, the luminance of each of the light regions (Fb1 to Fb4) affects the brightness of each part (which will be described later) of the shot image. For example, when a display pattern displayed in the first light region Fb1 is updated to another display pattern of higher luminance, mainly the upper-side part of the subject becomes brighter, and thus the upper-side part of the shot image becomes brighter.

[Operation Procedure of the Mirror Mode]

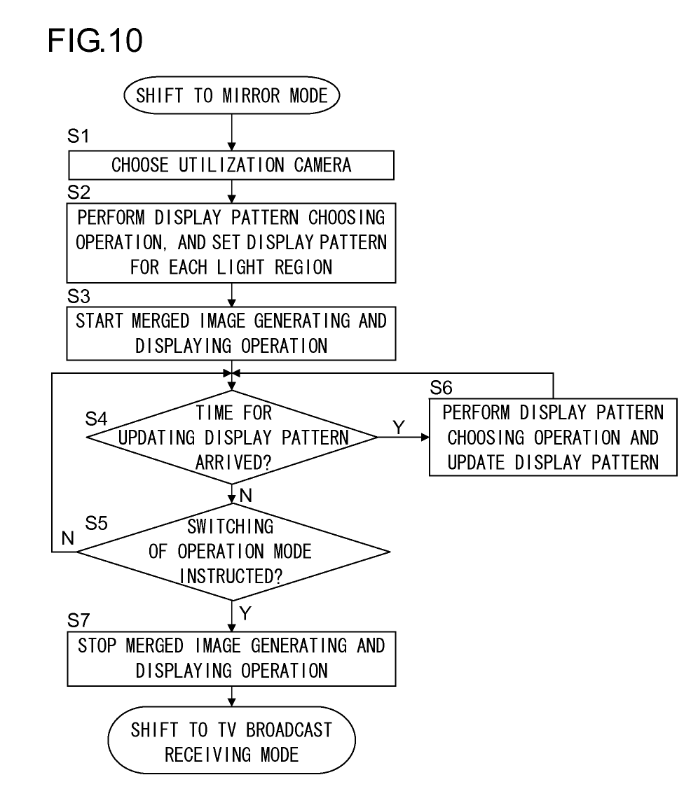

In light of the foregoing description, a detailed description will be given of the operation procedure of the image display device 1 when the operation mode is shifted to the “mirror mode,” with reference to the flow chart of FIG. 10.

First, the image display device 1 determines which of the first and second cameras 15a and 15b is to be chosen as a camera to be used in shooting to be performed (hereinafter, for the sake of convenience, referred to as a “utilization camera”) (step S1).

More specifically, the arithmetic and control portion 17 makes the first and second cameras 15a and 15b shoot a moving image of the subject. Meanwhile, the arithmetic and control portion 17 monitors whether or not a face of a person facing the image display device 1 is included in the image shot by any camera (15a or 15b). Incidentally, the method of detecting whether or not the face of a person facing the image display device 1 (for example, method of pattern matching) is included in the image or the method of detecting the position of the face are publicly known, and thus detailed descriptions thereof will be omitted here.

If a shot image obtained by one of the cameras (15a, 15b) alone includes such a face of a person, the arithmetic and control portion 17 chooses the camera that has obtained the shot image as the utilization camera. On the other hand, if shot images obtained by the cameras (15a, 15b) both include such a face of a person, the arithmetic and control portion 17 determines in which of the shot images the face is located closer to the center, and chooses the camera that has obtained the shot image having the face closer to the center as the utilization camera.

This allows the shooting portion 15 to shoot a face of any of persons of different heights more properly. For example, in a situation as shown in FIG. 4, the second camera 15b is chosen as the utilization camera, and it is possible to shoot the face of the person more properly (such that the face is in the vicinity of the center of the shot image).

Incidentally, when a face of a person is detected, which camera is chosen as the utilization camera may be displayed on the display 14 along with a message “Your face has been properly detected,” for example. Furthermore, the operation in step S1 is not limited to the above description, and, for example, the utilization camera may be chosen according to an instruction (a predetermined operation on the operation portion 18) from the user.

After the utilization camera is chosen, the image display device 1 first performs an operation for choosing a display pattern to be set for each of the light regions (Fb1 to Fb4) (hereinafter, for the sake of convenience, referred to as “display pattern choosing operation”) (step S2). The specific procedure of the display pattern choosing operation will be described later.

Thereafter, the image display device 1 starts an operation for sequentially generating a latest merged image and has it displayed on the display 14 (merged image generating and displaying operation) (step S3). More specifically, the shooting portion 15 performs shooting of a moving image of the subject by using the utilization camera, and sequentially sends data of the obtained moving image to the merged image generating circuit 16. On receiving the data, the merged image generating circuit 16 sequentially generates merged images to which a latest moving image is assigned, and has them displayed on the display surface.

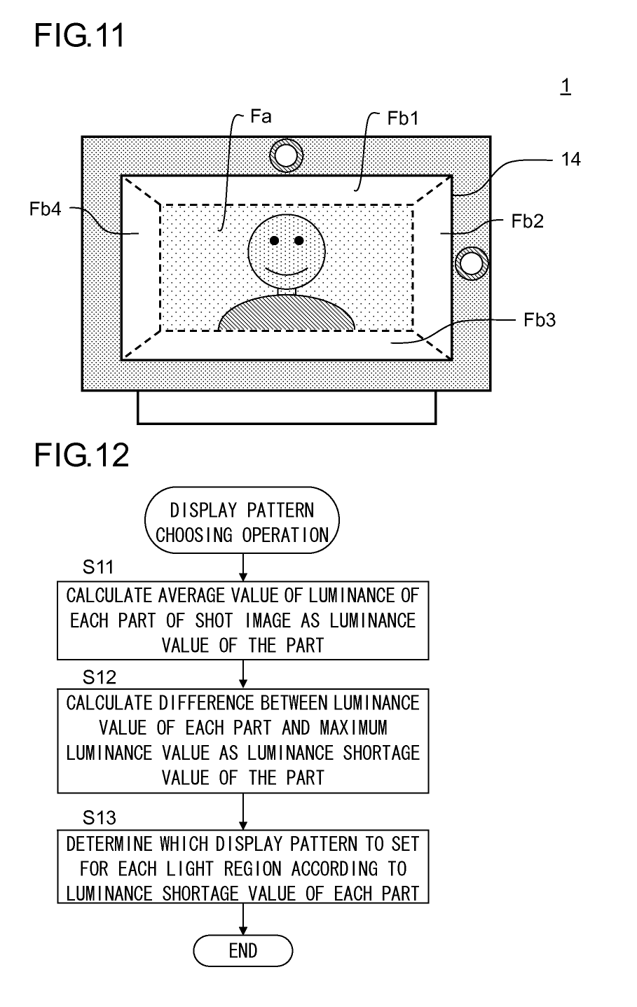

The merged image generating and displaying operation is realized in this way, and the sequentially generated merged images are displayed on the display 14. The merged images are, as shown in FIG. 11, displayed by using the whole area of the display surface. In the merged images displayed in the shot image region Fa, motion of the subject is reflected substantially in real time.

The merged image generating and displaying operation continues to be performed until the user gives an instruction to switch the operation mode to the “television broadcast receiving mode.” When the instruction is given (Y in step S5), the merged image generating and displaying operation is stopped (step S7), and the operation mode of the image display device 1 is switched to the “television broadcast switching mode.”

While performing the merged image generating and displaying operation, the image display device 1 monitors timing of updating display pattern setting (step S4). This timing is set, for example, as a predetermined constant cycle. When time for updating the display pattern setting arrives (Y in step S4), the image display device 1 performs the above-described display pattern choosing operation again such that the state of the moving image is improved, and updates the setting of the display pattern for each of the light regions (Fb1 to Fb4) to a newly chosen display pattern (step S6).

Here, the specific procedure of the display pattern choosing operation will be described with reference to the flow chart shown in FIG. 12. Incidentally, significant unevenness in brightness (significant difference between a bright portion and a dark portion) degrades the viewability for the user and may cause the user to feel something wrong with the image. Thus, the display pattern choosing operation aims at reduction of the unevenness in brightness of the moving image.

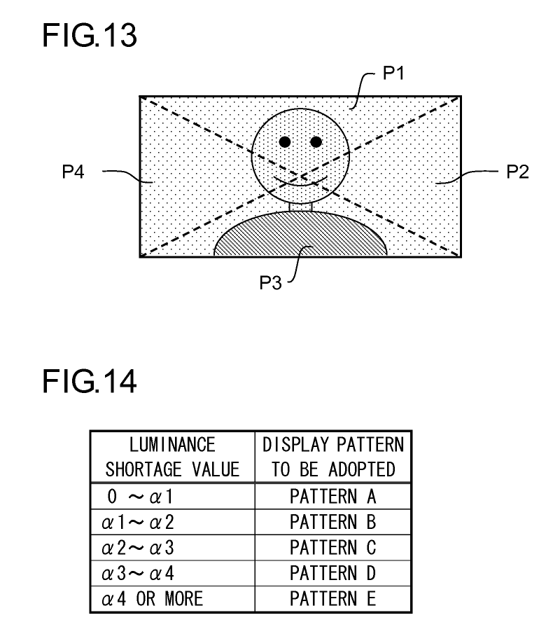

The arithmetic and control portion 17 divides the current latest shot image (one frame of the moving image) into four parts (parts separated by broken lines) as shown in FIG. 13, and calculates an average value of luminance of each part (luminance of the electrodes belonging to the part) as the luminance value of the part (step S11). The luminance value can be said to indicate the degree of brightness in the part.

Incidentally, as shown in FIG. 13, among these parts, a first part P1 is a part on the upper side of the shot image, a second part P2 is a part on the right side of the shot image, a third part P2 is a part on the lower side of the shot image, and a fourth part P4 is a part on the left side of the shot image. Thus, it can be said that the brightness of the first part P1 reflects the brightness of the upper-side part of the subject, the brightness of the second part P2 reflects the brightness of the right-side part of the subject, the brightness of the third part P3 reflects the lower-side part of the subject, and the brightness of the fourth part P4 reflects the left-side part of the subject.

This means that the brightness of the first light region Fb1 mainly affects the brightness of the first part P1, and thus the first light region Fb1 and the first part P1 can be considered to correspond to each other. Likewise, the second light region Fb2 and the second part P2, the third light region Fb3 and the third part P3, and the fourth light region Fb4 and the fourth part P4 can be considered to correspond to each other. Incidentally, by the degree of brightness of each part being detected, the brightness of the subject is detected such that the brightness of each of parts corresponding to the light regions (Fb1 to Fb4) is individually detected.

Next, the arithmetic and control portion 17 calculates a difference between the luminance value of each part and a maximum value (the maximum value of luminance values of all the parts) as a luminance shortage value of the part (step S12). The luminance shortage value can be said to indicate the degree of darkness in the part relative to the brightest part.

Next, according to the luminance shortage value of each part, the arithmetic and control portion 17 determines which display pattern should be set for each light region (step S13). More specifically, as shown in FIG. 14, correspondence between the luminance shortage values and display patterns to be adopted is determined in advance. And according to the correspondence, the display pattern to be set for the light region corresponding to each part is chosen.

For example, if the luminance shortage value in the first part P1 is α2 or more but less than α3, pattern C is chosen as the display pattern to be set for the first light region Fb1. That is, the larger the luminance shortage value of a part is, a display pattern of higher luminance is chosen as the display pattern to be set for the light region corresponding to the part. Values α1 to α4 are each able to be set to an appropriate value in advance by an experimental survey by using a test machine.

At the time when the operation of step S13 is completed, the display patterns to be set for the light regions are each set, which completes the current display pattern choosing operation. By the thus chosen display patterns being set for the light regions, the parts of the subject are illuminated such that the darker they are currently, the brighter they are illuminated. As a result, unevenness in brightness of the shot image (moving image) is reduced as much as possible.

For example, in a case in which there is an illumination device such as a fluorescent lamp to the left front of the subject, unless some measure is taken, only the left-side part of the subject is illuminated bright by the illumination device, and thus the right-side part of the subject may become relatively dark. Under such a condition, according to the image display device 1 performing the above-described series of operations, the luminance of the second light region Fb2 becomes relatively high (that is, the right-side part of the subject is illuminated brighter) and thereby the unevenness in the brightness of the shot image is alleviated.

According to the display pattern choosing operation performed as described above, it is possible to achieve the object of alleviating the unevenness in brightness of the shot image. As to the specific contents of the display pattern choosing operation, various embodiments are possible. For example, the contents of the operation may be aimed at maintaining the brightness of all the parts in the shot image at a given level or higher (i.e., eliminating a part that is darker than the given level).

The display pattern choosing operation can be considered as processing in which the brightness of the subject is detected such that the brightness of each of parts of the subject corresponding to the light regions (Fb1 to Fb4) are individually detected, and according to the result of the detection, it is determined, with respect to each of the light regions (Fb1 to Fb4), which of the plurality of display patterns (the patterns A to E) is to be assigned to the light region. And the processing of detecting the brightness of the subject such that the brightness of each part of the subject is detected is realized through processing in which the shot image is divided into a plurality of parts (P1 to P4) corresponding to the light regions (Fb1 to Fb4) and the brightness of the shot image is detected by detecting the brightness of each of the parts.

Incidentally, in the present embodiment, the camera (15a or 15b) used for shooting the moving image of the subject is also used as part of means for detecting the brightness of the subject to thereby make more effective use of the camera. Alternatively, a sensor or the like may be separately provided for detecting the brightness of the subject. Furthermore, various methods can be adopted as the method of detecting the brightness of the subject by using the shot image.

[Making Display of the Light Regions Selective]

In the mirror mode, the image display device 1 displays a merged image including the light regions (Fb1 to Fb4). In this regard, the user may be allowed to select whether or not the light regions are displayed. This can be realized by making the display style on the display surface in the mirror mode switchable, by a predetermined operation on the operation portion 18, between a style in which the merged image is displayed (the light regions included) and a style in which only a moving image is displayed (the light regions not included).

Incidentally, preferably, in the case where only the moving image is displayed, the merged image generating and displaying operation is not performed, but instead, shooting of the moving image of the subject is performed by the utilization camera and the obtained moving image is displayed on the display surface. The moving image is preferably displayed by using the whole area of the display surface such that it is displayed as large as possible.

By allowing the user to select whether or not to display the light regions, it is possible to make the image display device1 more appropriate for a situation at any time. For example, an arrangement is possible such that the light regions are displayed if the priority is given to the brightness of the displayed moving image, etc., while the light regions are not displayed if the priority is given to the size of the displayed moving image, etc. Furthermore, an arrangement is also possible such that the light regions are not displayed if the user feels the display of the light regions is glaring,

[Allowing Shot Image to be Recorded and Played Back]

As described above, in the mirror mode, the image display device 1 obtains data of a moving image of a subject. For this purpose, the image display device 1 may be provided with a recording device for recording the data of the moving image (image recording) such that the moving image can be displayed (played back) later by using the recorded data. In this case, as an operation mode of the image display device 1, a “play back mode” is prepared in addition to the television broadcast receiving mode and the mirror mode, and in the play back mode, the playing back is performed.

With the image display device 1 capable of recording and playing back a moving image as described above, the user is able to check his or her own appearance some other time by making the image display device 1 perform the playing-back as he or she desires. Incidentally, while the moving image is being played back, there is no need of shooting the subject. Thus, when the playing back is realized by using the display surface, it is desirable that the light regions (Fb1 to Fb4) be not displayed and the played-back moving image is displayed by using the whole area of the display surface.

[Use of Communication System]

The image display device 1 may be connected to some communication system such that the image display device 1 is able to communicate with another communication apparatus connected to the communication system. This helps make the image display device 1 more convenient.

For example, the image display device 1 may be connected to the Skype(™) System (hereinafter, Skype System) which is a kind of VoIP (Voice over Interne Protocol) communication system such that the image display device 1 is provided with a function of performing communication by using this communication system.

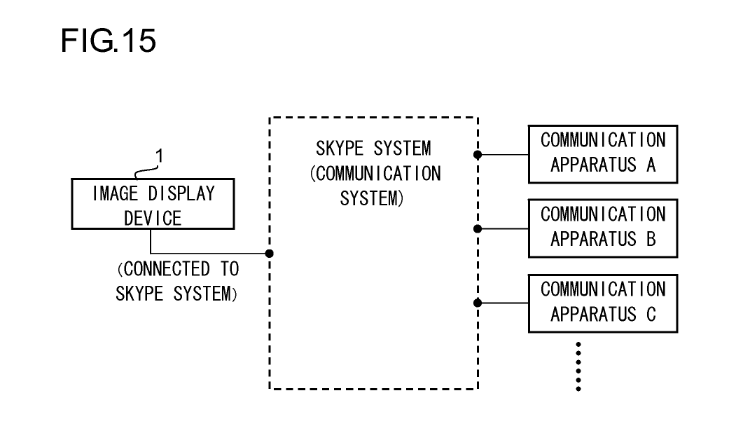

This allows the image display device 1 to be connected as shown in FIG. 15 to the Skype system as a communication system, and to communicate with another communication apparatus (in FIGS. 15, communication apparatuses A to C are shown as an example) that is connected to this communication system.

As a result, a user of the image display device 1 is able to communicate with a user of another communication apparatus connected to the Skype system. Incidentally, the Skype system is known as a communication system that realizes an audio call or a video call between users by using the Internet.

The image display device 1 may be structured to send, in response to an instruction from the user, etc., information of a moving image shot (obtained) by the shooting portion 15, etc. to another communication apparatus by using the Skype system. If, for example, the image display device 1 is capable of sending, for example, a shot moving image of a subject in a form such as a video call by using the Skype system, it will significantly increase the convenience of the image display device 1.

Incidentally, in comparison with the conventional Internet phone, etc., the Skype system is significantly advantageous in (1) that no matter how many users access to the Skype system, the service is free and does not become slow, (2) that it can be used even if a firewall and an address transformation unit (such as a BB router) is placed between the user and the Internet as in a corporate network or a household, and (3) that the sound quality in talking over the Skype system is better than in talking over the existing telephone. These advantages are exerted by processing various functions such as a phone call between users by using a P2P (peer to peer) technology.

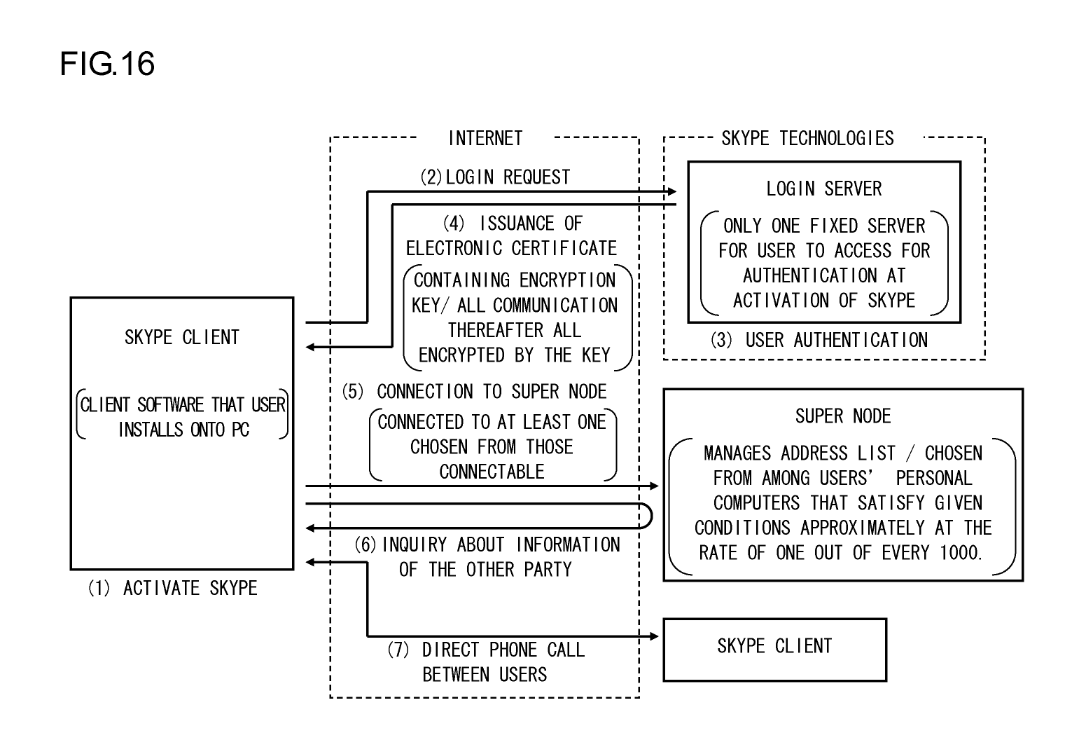

As shown in FIG. 16, the service of the Skype system is composed of the three elements of a Skype client, a login server, and a super node. The Skype client is dedicated software that the user installs onto his or her personal computer. The installation of this software makes it possible to use functions of not only the voice call function but also chat, file transfer, and presence functions.

The login server accepts a login request from the Skype client and authenticates the user. The login server alone is a fixed server that always exists in a fixed location. The login server also has a role of giving a “cipher key” to the Skype client that has passed the authentication, such that the Skype client can safely communicate with another client.

The super node is the core element of the Skype service that performs various functions such as “address list management,” “calling the other party,” and “relay of voice.” The super node is practically a user's Skype client on the Internet. Among client personal computers that the Skype client operates, ones that satisfy the following conditions are selected as a super node as necessary: having a global IP address, having sufficient processing capacity and line speed, operating stably for a long time, etc.

Any of the other Skype clients, after logging in, selects and connects with one of such super nodes, and thereafter makes inquiries about information of the other party as necessary, while continuously remaining connected to the super node.

[Others]

In the above-described image display device 1, the operation mode related to its own operation is set such that it can be updated to either the television broadcast receiving mode or the mirror mode according to an instruction from the user. That is, the image display device 1 can be used, to suit the convenience of the user, as a television broadcast receiver or as a substitute for a mirror.

In the television broadcast receiving mode, images sequentially obtained by being received are displayed on the display surface. On the other hand, in the mirror mode, a merged image including a shot image region Fa and light regions (Fb1 to Fb4) is displayed on the display surface. This can also be described in the following manner: that is, the display surface is divided into a part that is compared to a mirror (part corresponding to the shot image region Fa) and a part compared to a shooting light (part corresponding to the light regions (Fb1 to Fb4)).

For a person as an observer to be able to see his or her appearance, a moving image (in which the person is present) obtained by the shooting portion 15 is displayed in the part compared to a mirror. That is, the part is used as if it were a mirror. For the brightness of the person as a subject to be able to be adjusted, an image whose luminance is adjusted according to the brightness of the subject is displayed in the part compared to a shooting light. That is, this part is used as if it were a shooting light.

Incidentally, with the image display device 1, which is structured to adjust the brightness of the subject itself, more natural shot images can be obtained than in a case in which the brightness of a shot images is adjusted by the processing of image data (that is, an image quality adjustment function is used). However, in the image display device 1, the image quality adjustment function may be provided for auxiliary or backup use.

In contrast to a case in which a shooting light is separately provided, with the image display device 1, in which part of the display surface is used as substitute for a shooting light, there is no need of securing a space for setting the shooting light or of providing a new component for forming the shooting light, and thus it is easy to achieve a more inexpensive and smaller device. However, in the image display device 1, a shooting light may be separately provided for auxiliary or backup use.

As described hereinabove, the image display device 1 embodying the present invention the display surface that displays an image by emitting light; the cameras (15a, 15b) that shoot a subject; a functional portion (a moving image obtaining portion) that makes the cameras shoot a moving image of a subject to thereby obtain a moving image; and a functional portion (a merged image generating portion) that generates a merged image and has it displayed on the display surface when the moving image shooting is performed. Furthermore, the image display device 1 stores a plurality of kinds of display patterns that indicates display states that are different from each other in luminance.

The merged image is structured such that the shot image region Fa and the light regions (Fb1 to Fb4) are formed in the predetermined positions, and a moving image of a subject is assigned to the shot image region Fa, while, to each of the light regions (Fb1 to Fb4), any of plurality of kinds of display patterns (patterns A to E) is assigned.

Furthermore, the cameras (15a, 15b) are for shooting, as a subject, an object located to be illuminated with light emitted from the display surface, and the merged image generating portion detects the brightness of the subject and, according to the result of the detection, determines which of the plurality of kinds of display patterns (patterns A to E) to assign to each of the light regions (Fb1 to Fb4).

Thus, according to the image display device 1, since a moving image of a subject obtained by moving image shooting is displayed on the display surface, it can be used as a substitute for a mirror, and in addition, in the moving image shooting, the display patterns are also displayed on the display surface. Furthermore, in the display surface, part thereof on which the display patterns are displayed can be made to function as a shooting light for adjusting the brightness of the subject. Thus, according to the image display device 1, it is possible to properly adjust the brightness of the subject without separately providing a shooting light.

With attention focused on the form of the merged image, the light regions (Fb1 to Fb4) are formed along the frame of the merged image so as to surround the shot image region Fa. From another viewpoint, the shot image region Fa is formed in the center of the merged image, and the light regions (Fb1 to Fb4) are formed such that the shot image region is located between some of the light regions (Fb1 and FB3, or Fb2 and Fb4).

This makes the following possible: sufficient area is secured for the shot image region Fa to make large the distances between the first and third light regions Fb1 and Fb3 and between the second and fourth light regions Fb2 and Fb4, to allow light emitted from the light regions illuminate the subject from significantly different directions as shown in FIGS. 8 and 9. As a result, it is possible to correspond what is illuminated by each of the light regions (Fb1 to Fb4) to parts of the subject over a wide range.

Furthermore, the image display device 1 can also be regarded as a television broadcast receiver provided with a function of being used as a substitute for a mirror. The function of being used as a substitute for a mirror, however, can be provided in various kinds of apparatuses (image display devices) such as mobile telephone terminals and personal computers that display an image on a display.

The embodiment of the present invention described hitherto as an example is not meant to limit the present invention. In addition to the embodiment described above, many modifications and variations are possible within the spirit of the present invention.

According to the image display device of the present invention, since a moving image of a subject obtained by moving image shooting is displayed on the display surface, it can be used as a substitute for a mirror, and in addition, in the moving image shooting, the display patterns are also displayed on the display surface. Thus, by using part of the display surface on which the display patterns are displayed as a substitute for a shooting light, it is possible to appropriately adjust the brightness of the subject without separately providing a shooting light.

What is claimed is:

1. An image display device, comprising:
a display surface that displays an image by emitting light;
a camera that shoots a subject;
a moving image obtaining portion that obtains a moving image by making the camera perform shooting of a moving image of the subject; and
a merged image generating portion that, when the shooting of the moving image of the subject is performed, generates a merged image and makes the display surface display the merged image,
wherein
the image display device stores a plurality of kinds of display patterns indicating display states that are different from one another in brightness; and
a shot image region and a light region are provided in predetermined positions in the merged image, the moving image being assigned to the shot image region, and any of the plurality of kinds of display patterns being assigned to the light region.

2. The image display device of claim 1,
wherein
the camera shoots, as the subject, an object located to be illuminated by light emitted from the display surface; and
the merged image generating portion performs detection of brightness of the subject and, according to a result of the detection, determines which of the plurality of kinds of display patterns is to be assigned to the light region.

3. The image display device of claim 2,
wherein
the merged image generating portion obtains a shot image of the subject shot by the camera, and, based on the shot image, performs the detection of the brightness of the subject.

4. The image display device of claim 3,
wherein
the light region is formed of a plurality of subregions;
the merged image generating portion performs the detection of the brightness of the subject such that brightness of parts of the subject corresponding to the subregions is detected on a part-by-part basis, and thereafter, according to a result of the detection, the merged image generating portion determines which of the plurality of kinds of display patterns is to be assigned to the light region on a subregion-by-subregion basis: and
processing of performing the detection of the brightness of the subject on the part-by-part basis is realized through processing in which the shot image is divided into a plurality of parts corresponding to the subregions on a one-to-one basis, and detection of brightness of the shot image is performed by detecting brightness of the parts on a part-by-part basis.

5. The image display device of claim 1,
wherein
the shot image region is provided substantially in a center of the merged image, and the light region is formed such that subregions sandwich the shot image region.

6. The image display device of claim 2,
wherein
the shot image region is provided substantially in a center of the merged image, and the light region is formed such that subregions sandwich the shot image region.

7. The image display device of claim 3,
wherein
the shot image region is provided substantially in a center of the merged image, and the light region is formed such that subregions sandwich the shot image region.

8. The image display device of claim 4,
wherein
the shot image region is provided substantially in a center of the merged image, and the light region is formed such that the subregions sandwich the shot image region.

9. The image display device of claim 1,
wherein
information of a moving image obtained by the moving image obtaining portion is transmitted by using a communication system.

10. The image display device of claim 9,
wherein
the communication system is the Skype(™) system.

11. An image display device, comprising:
a display surface that displays an image by emitting light;
a signal receiving portion that performs reception of television broadcast;
a camera that shoots, as a subject, a person present in front of the display surface;
a moving image obtaining portion that obtains a moving image by making the camera perform shooting of moving image of the subject; and
an operation mode setting portion that updatably sets a mode related to operation of the image display device to any of a plurality of modes including a television broadcast receiving mode and a mirror mode,
wherein,
in the television broadcast receiving mode, images sequentially obtained by the reception are displayed on the display surface; and
in the mirror mode, the display surface is divided into a part compared to a mirror and a part compared to a shooting light, the moving image is displayed in the part compared to a mirror to enable the person to see his or her own appearance, while an image having luminance adjusted according to brightness of the subject is displayed in the part compared to a shooting light to thereby adjust the brightness of the subject.

12. An image display device, comprising:
a display surface that displays an image by emitting light;
a camera that shoots a subject;
a moving image obtaining portion that obtains a moving image by making the camera perform shooting of moving image of the subject; and
a merged image generating portion that generates, when the shooting of the moving image of the subject is performed, a merged image and makes the display surface display the merged image,
wherein a shot image region and a high-luminance region are provided in predetermined positions in the merged image, the moving image being assigned to the shot image region, and the high-luminance region having luminance higher than luminance of the shot image region.
